(19) United States
(12) Patent Application Publication
(10) Pub. No.: US 2013/0024046 A1
(43) Pub. Date: Jan. 24, 2013

(54) POWER TRANSMISSION CONTROLLER, POWER RECEPTION CONTROLLER, POWER TRANSMISSION SYSTEM, AND DATA COMMUNICATION METHOD OF POWER TRANSMISSION SYSTEM

(71) Applicant: PANASONIC CORPORATION, Osaka (JP)

(72) Inventors: Hiroshi TORIYA, Osaka (JP); Kouji KANAMORI, Kanagawa (JP); Atsushi ISAKA, Shiga (JP); Kazuhiro SUZUKI, Shiga (JP); Kyohei KADA, Shiga (JP); Takaoki MATSUMOTO, Shiga (JP)

(73) Assignee: PANASONIC CORPORATION, Osaka (JP)

(21) Appl. No.: 13/627,235

(22) Filed: Sep. 26, 2012

Related U.S. Application Data
(63) Continuation of application No. PCT/JP2011/000785, filed on Feb. 14, 2011.

(30) Foreign Application Priority Data
Mar. 26, 2010 (JP) 2010-073180

(51) Int. Cl. H02J 17/00; G06F 1/26

(52) U.S. Cl. 700/297; 307/104

(57) ABSTRACT

A power transmission controller includes a control unit configured to output to a power transmission unit a drive signal modulated according to data and control a driving operation of the power transmission unit, a data storage unit configured to store data transferred from a power transmission device to a power reception device every time the data is input to the power transmission device; and a comparison unit configured to compare data newly input to the power transmission device to the data stored in the data storage unit to determine whether or not there is a match between these data, wherein a control unit is configured to output the drive signal modulated based on the newly input data to the power transmission unit and transmit the newly input data to the power reception device, if the comparison unit determines that these data do not match; and the control unit is configured not to transmit the newly input data to the power reception device, if the comparison unit determines that there is a match between these data. A power reception controller is configured in the same manner.

### CROSS REFERENCE TO THE RELATED APPLICATION

This is a continuation application under 35 U.S.C. 111(a) of pending prior International application No. PCT/JP2011/000785, filed on Feb. 14, 2011. The disclosure of Japanese Patent Application No. 2010-073180 filed on Mar. 26, 2010 including specification, drawings and claims are incorporated herein by reference in its entirety.

### BACKGROUND OF THE INVENTION

1. Field of the Invention

The present invention relates to a power transmission controller, a power reception controller, a power transmission system, and a data communication method of the power transmission system.

2. Description of the Related Art

In recent years, a contactless power transmission method (also referred to as wireless power transmission method) which enables power transmission without a contact of a metal portion by utilizing electromagnetic induction has attracted lots of attention. Japanese Laid-Open Patent Application Publication No. 2010-28932 discloses a prior art of such a contactless power transmission method. This prior art also implements data communication at an application level between a host at a power transmission side (power transmission host) and a host at a power reception side (power reception host) by utilizing the contactless power transmission method (electromagnetic induction). Hereinafter, a data communication method of a power transmission system disclosed in Japanese Laid-Open Patent Application Publication No. 2010-28932 will be described with reference to FIGS. 4 and 5. FIGS. 4A to 4C are block diagrams showing data transfer from a power transmission host to a power reception host utilizing a conventional contactless power transmission method. FIG. 5 is a schematic view showing data transfer from the power transmission host to the power reception host utilizing the conventional contactless power transmission method.

Referring to FIG. 4, a power transmission system of FIG. 4 is configured in such a manner that a primary coil LA and a secondary coil LB are electromagnetically coupled together to transmit data in a contactless (wireless) manner from a power transmission device 110 to a power reception device 140 and supply electric power to a load (not shown) of the power reception device 140. The power transmission device 110 includes the primary coil LA, a, power transmission unit 112, and a power transmission controller 120. The power transmission controller 120 includes a control unit 122 for performing control processes in the power transmission controller 120, a host interface 127 for performing communication with a power transmission host 102, a register unit 123 which can be accessed by the power transmission host 102 via the host interface 127, and a load state detection circuit 130. The power reception device 140 includes the secondary coil LB, a power reception unit 142, a load modulation unit 146, a power feeding control unit 148, and a power reception controller 150. The power reception controller 150 includes a control unit 152 for performing control processes in the power reception controller 150, a host interface 157 for performing communication with a power reception host 104, a register unit 153 which can be accessed by the power reception host 104 via the host interface 157, and a detection circuit 159.

When an authentification process between the power transmission side and the power reception side is completed properly, the power transmission side starts normal power transmission to the power reception side. Thereby, for example, charging of a battery of the load starts. When the normal power transmission starts, the power transmission device 110 is placed in a state in which it is able to accept a communication request from the power transmission host 102. For example, in the example of FIG. 4A, the power transmission host 102 issues a communication request command for OUT transfer, which is written to the register unit 123 via the host 11F127. Thus, the power transmission side shifts to a communication mode, in which transmission conditions and communication conditions for the normal power transmission are shifted to those for the communication mode. In addition, a determination process for regular authentification is deactivated.

The communication request command for OUT transfer, which is issued from the power transmission host 102, is transmitted from the power transmission side (primary side) to the power reception side (secondary side) by a contactless (wireless) power transmission method. Receiving the communication request command, the power reception side shifts to the communication mode, and deactivates the power feeding to the load. In addition, the power reception side deactivates outputting the data in the authentification process. In this way, by deactivating the power feeding to the load, it is possible to prevent a fluctuation in the load from negatively affecting load modulation for data communication in the communication mode. The power reception side notifies the power reception host 104 that the communication request command has been received, by using the register unit 153. Thus, the power reception host 104 confirms the communication request command for OUT transfer, which is issued from the power transmission side.

Then, as shown in FIG. 4B, to carry out OUT transfer the power transmission host 102 writes a data transfer command and the corresponding data to the register unit 123 via the host I/F 127. Thereby, the data transfer command and the corresponding data are transmitted from the power transmission side to the power reception side by the contactless power transmission method. Receiving the data transfer command at the power reception side, the power reception host 104 is notified that the data transfer command has been received, by using the register unit 153. In the above described manner, the power reception host 104 confirms that the power reception side has received the data from the power transmission side.

Then, as shown in FIG. 4C, the power reception host 104 reads the data written to the register unit 153 via the host I/F 157. Thereby, OUT transfer in which the data are transferred from the power transmission host 102 to the power reception host 104 by utilizing the contactless power transmission method is implemented.

FIG. 5 shows an exemplary signal waveform for describing OUT transfer of FIG. 4 more specifically.

At A1 of FIG. 5, the power transmission side transmits the OUT transfer command COM (OUT) which is the communication request command, to the power reception side, by utilizing the contactless power transmission method. A6h is a start command, and CRC8 is a CRC code. Receiving the OUT transfer command COM (OUT), the power reception side transmits an ACK command COM (ACK) corresponding to the OUT transfer command COM (OUT) to the power transmission side, as shown in A2 of FIG. 5. Based on the ACK command COM (ACK), the power transmission host 102 can confirm that the power reception host 104 has received the OUT transfer command COM (OUT) properly. Then, as shown in A3 of FIG. 5, the power transmission host 102 which has received the ACK command, transmits a data transfer command COM (DATA0) and the corresponding data DATA0 of 8 bytes, to the power reception host 104. Receiving data transfer command COM (DATA0) and the corresponding data DATA0, the power reception host 104 transmits an ACK command COM (ACK) corresponding to the data transfer command COM (DATA0) to the power transmission host 102, as shown in FIG. A4 of FIG. 5. Based on the ACK command COM (ACK), the power transmission host 102 can confirm that the power reception host 104 has received the data DATA0 properly.

The above stated transfer process is repeated until a desired data number is reached, thereby implementing the OUT transfer, in which data of the desired data number is transferred from the power transmission host 102 to the power reception host 104. To improve the reliability of data transfer, the data transfer command COM (DATA0) associated with the data DATA0 is transferred while being toggled at A3 in FIG. 5, and the data transfer command COM (DATA1) associated with the data DATA1 is transferred while being toggled at A5 in FIG. 5.

An IN transfer command COM (IN) for requesting data transfer from the power reception host 104 to the power transmission host 102 is transmitted and received as in the case of the OUT transfer command COM (OUT).

### SUMMARY OF THE INVENTION

There may be cases where data having the same content is transferred many times successively in the data communication between the power transmission host and the power reception host. In this case, according to the prior art disclosed in Japanese Laid-Open Patent Application Publication No. 2010-28932, as soon as the data transfer command (the above stated OUT transfer command COM (OUT)) and the corresponding data from the power transmission host 102 to the power reception host 104, is stored in the register unit 123 of the power transmission controller 120 via the host I/F 127, the normal power transmission shifts to the communication mode promptly. Because of this, for example, the data having the same content is transmitted from the power transmission host 102 to the power reception host 104 many times, which results in a low communication efficiency of the communication performed between the hosts 102, 104. In the case of the data communication by the contactless power transmission method, the primary coil and the secondary coil consume great electric power. Therefore, if unvaried and unnecessary data is transferred many times, then a power efficiency decreases. The same applies to the transfer from the data transfer command (the above stated transfer command COM (IN)) from the power reception host 104 to the power transmission host 102.

The present invention is directed to solving the above mentioned problems, and an object of the present invention is to provide a power transmission controller, a power reception controller, a power transmission system, and a data communication method of the power transmission system, in which a communication efficiency between a power transmission device and a power reception device is improved.

According to one aspect of the present invention, there is provided a power transmission controller included in a power transmission device in a power transmission system, including the power transmission device, and a power reception device, the power transmission device including a primary coil and a power transmission unit which drives the primary coil based on a drive signal and transmits AC power corresponding to the drive signal, the power reception device including a secondary coil and a power reception unit which receives AC power induced on the secondary coil, the power transmission system being configured such that the primary coil and the secondary coil are electromagnetically coupled together to receive in the power reception unit the AC power transmitted from the power transmission unit, the power transmission controller comprising: a control unit configured to output the drive signal modulated based on data, to the power transmission unit to control a driving operation of the power transmission unit; a data storage unit configured to store data transferred from the power transmission device to the power reception device every time an input signal containing the data is input to the power transmission device; and a comparison unit configured to compare data contained in an input signal which is newly input to the power transmission device to the data stored in the data storage unit to determine whether or not there is a match between the data contained in the input signal and the data stored in the data storage unit; wherein the control unit is configured to output the drive signal modulated based on the newly input data to the power transmission unit and transmit the newly input data to the power reception device, if the comparison unit determines that the data contained in the input signal and the data stored in the storage unit do not match; and the control unit is configured not to transmit the newly input data to the power reception device, if the comparison unit determines that there is a match between the data contained in the input signal and the data stored in the storage unit.

The power transmission controller may further comprise a host interface configured to perform communication with a power transmission host coupled to the power transmission device, and the data storage unit may be accessible by the power transmission host via the host interface.

As used herein, the input signal containing the data refers to a data transfer command including data transferred from the power transmission host to the power reception host, status signals including data indicating statuses of the power transmission device which are transferred from the power transmission device to the power reception device, etc. In accordance with this configuration, if the data newly received from the power transmission host via the host interface matches the data stored previously in the data storage unit, the power transmission host need not transmit the newly received data to the power reception host based on a contactless power transmission method. This can improve a communication efficiency in the power transmission system. In the case of data communication based on the contactless power transmission method, the primary coil and the secondary coil consume great electric power. In accordance with this configuration, since it is not necessary to transmit unnecessary and unvaried data from the power transmission host to the power reception host, a power efficiency of the power transmission system can be improved.

According to another aspect of the present invention, there is provided a power reception controller included in a power reception device in a power transmission system including a power transmission device, and the power reception device, the power transmission device including a primary coil and a power transmission unit which drives the primary coil based on a drive signal and transmits AC power corresponding to the drive signal, the power reception device including a secondary coil and a power reception unit which receives AC power induced on the secondary coil, the power transmission system being configured such that the primary coil and the secondary coil are electromagnetically coupled together to receive in the power reception unit, the AC power transmitted from the power transmission unit, the power reception controller comprising: a control unit configured to change a load state at a power reception side with respect to electric power received in the power reception unit; a data storage unit configured to store data transferred from the power reception device to the power transmission device every time an input signal containing the data is input to the power reception device; a comparison unit configured to compare data contained in an input signal which is newly input to the power reception device to the data stored in the data storage unit to determine whether or not there is a match between the data contained in the input signal and the data stored in the data storage unit; wherein the control unit is configured to change the load state at the power reception side based on the newly input data and transmit the newly input data to the power transmission device, if the comparison unit determines that the data contained in the input signal and the data stored in the data storage unit do not match; and the control unit is configured not to transmit the newly input data to the power transmission device, if the comparison unit determines that there is a match between the data contained in the input signal and the data stored in the storage unit.

The power reception controller may further comprise a host interface configured to perform communication with a power reception host coupled to the power reception device; wherein the data storage unit is accessible by the power reception host via the host interface.

As used herein, the input signal containing the data refers to a data transfer command including data transferred from the power reception host to the power transmission host, status signals including data indicating statuses of the power reception device which are transferred from the power reception device to the power transmission device, etc. In accordance with this configuration, if the data newly received from the power reception host via the host interface matches the data stored previously in the data storage unit, the power reception host need not transmit the newly received data to the power transmission host based on the contactless power transmission method. This can improve a communication efficiency in the power transmission system. In accordance with this configuration, since it is not necessary to transmit unnecessary and unvaried data from the power reception host to the power transmission host, a power efficiency of the power transmission system can be improved.

According to another aspect of the present invention, there is provided a power transmission system comprising a power transmission device including a primary coil and a power transmission unit which drives the primary coil based on a drive signal and transmits AC power corresponding to the drive signal and a power reception device including a secondary coil and a power reception unit which receives AC power induced on the secondary coil, the power transmission system being configured such that the primary coil and the secondary coil are electromagnetically coupled together to receive in the power reception unit the AC power transmitted from the power transmission unit, wherein the power transmission device includes: a first control unit configured to output a drive signal modulated based on data, to the power transmission unit to control a driving operation of the power transmission unit; a first data storage unit configured to store data transferred from the power transmission device to the power reception device every time an input signal containing the data is input to the power transmission device; and a first comparison unit configured to compare data contained in an input signal which is newly input to the power transmission device to the data stored in the data storage unit to determine whether or not there is a match between the data contained in the input signal and the data stored in the data storage unit; wherein the first control unit is configured to output the drive signal modulated based on the newly input data to the power transmission unit and transmits the newly input data to the power reception device, if the first comparison unit determines that the data contained in the input signal and the data stored in the first data storage unit do not match; and the first control unit is configured not to transmit the newly input data to the power reception device, if the first comparison unit determines that there is a match between the data contained in the input signal and the data stored in the storage unit; wherein the power reception device includes: a second control unit configured to change a load state at a power reception side with respect to electric power received in the power reception unit; a second data storage unit configured to store data transferred from the power reception host to a power transmission host of the power transmission device every time an input signal containing the data is input to the power reception device; a second comparison unit configured to compare data contained in an input signal which is newly input to the power reception device and the data stored in the data storage unit to determine whether or not there is a match between the data contained in the input signal and the data stored in the second data storage unit; wherein the second control unit is configured to change the load state at the power reception side based on the newly input data and transmit the newly input data to the power transmission device, if the second comparison unit determines that the data contained in the input signal and the data stored in the data storage unit do not match; and the second control unit is configured not to transmit the newly input data to the power transmission device if the second comparison unit determines that there is a match between the data contained in the input signal and the data stored in the storage unit.

The power transmission system may further comprise a first host interface configured to perform communication with a power transmission host coupled to the power transmission device, and the first data storage unit may be accessible by the power transmission host via the first host interface.

The power transmission system may further comprise a second host interface configured to perform communication with a power reception host coupled to the power reception device; and the second data storage unit may be accessible by the power reception host via the second host interface.

In accordance with this configuration, since the data having the same content is not transferred many times successively between the power transmission host and the power reception host, a traffic quantity of inter-host communication can be suppressed, and a communication efficiency and a power efficiency in the power transmission system can be improved.

The power transmission system may further comprise a load state detection circuit configured to detect data transmitted from the power reception device based on a change in a terminal electric potential of the primary coil which is caused by a change in a load state at the power reception side; and the first control unit may be configured to output an interruption signal, if the data is detected by the load state detection circuit.

In accordance with this configuration, since the power transmission host can perform another processes before the interruption signal is received from the power transmission device, a processing burden or the like placed on the power transmission host can be lessened.

In the power transmission system, the power reception device may further include a detection circuit configured to demodulate the AC power transmitted according to the modulated drive signal and received in the power reception unit to detect the data transmitted from the power transmission device; and the second control unit may be configured to output an interruption signal, if the data is detected by the detection circuit.

In accordance with this configuration, since the power reception host can perform another processes before the interruption signal is received from the power reception device, a processing burden or the like placed on the power reception host can be lessened.

According to a further aspect of the present invention, there is provided a data communication method of a power transmission system comprising a power transmission device including a primary coil and a power transmission unit which drives the primary coil based on a drive signal and transmits AC power corresponding to the drive signal and a power reception device including a secondary coil and a power reception unit which receives AC power induced on the secondary coil, the power transmission system being configured such that the primary coil and the secondary coil are electromagnetically coupled together to receive in the power reception unit the AC power transmitted from the power transmission unit, wherein the power transmission device includes: a first control unit configured to output a drive signal modulated based on data, to the power transmission unit to control a driving operation of the power transmission unit; a first data storage unit configured to store data transferred from the power transmission device to the power reception device every time an input signal containing the data is input to the power transmission device; and a first comparison unit configured to compare data contained in an input signal which is newly input to the power transmission device to the data stored in the first data storage unit to determine whether or not there is a match between the data contained in the input signal and the data stored in the first data storage unit; wherein the power reception device includes: a second control unit configured to change a load state at a power reception side with respect to electric power received in the power reception unit; a second data storage unit configured to store data transferred from the power reception host to a power transmission host of the power transmission device every time an input signal containing the data is input to the power reception device; and a second comparison unit configured to compare data contained in an input signal which is newly input to the power reception device to the data stored in the second data storage unit to determine whether or not there is a match between the data contained in the input signal and the data stored in the second data storage unit; the data communication method comprising: using the first control unit of the power transmission device, outputting the drive signal modulated based on the newly input data to the power transmission unit and transmitting the newly input data to the power reception device, if the first comparison unit determines that the data contained in the input signal and the data stored in the first data storage unit do not match; using the first control unit of the power transmission device, not transmitting the newly input data to the power reception device, if the first comparison unit determines that there is a match between the data contained in the input signal and the data stored in the first data storage unit; using the second control unit of the power reception device, changing the load state at the power reception side based on the newly input data and transmitting the newly input data to the power transmission device, if the second comparison unit determines that the data contained in the input signal and the data stored in the second data storage unit do not match; and using the second control unit of the power reception device, not transmitting the newly input data to the power transmission device, if the second comparison unit determines that there is a match between the data contained in the input signal and the data stored in the second data storage unit.

The above and further objects, features and advantages of the present invention will more fully be apparent from the following detailed description of preferred embodiments with accompanying drawings.

### BRIEF DESCRIPTION OF THE DRAWINGS

FIG. 1 is a block diagram showing the configuration of a power transmission system according to an embodiment of the present invention.

FIG. 2A is a block diagram showing data communication from a power transmission side to a power reception side.

FIG. 2B is a block diagram showing data communication from the power reception side to the power transmission side.

FIG. 3 is a flowchart showing a data communication operation of the power transmission system according to the embodiment of the present invention.

FIG. 4A is a block diagram showing data transfer from a power transmission host to a power reception host by utilizing a conventional contactless power transmission method.

FIG. 4B is a block diagram showing data transfer from the power transmission host to the power reception host by utilizing the conventional contactless power transmission method.

FIG. 4C is a view showing data transfer from the power transmission host to the power reception host by utilizing the conventional contactless power transmission method.

FIG. 5 is a schematic diagram showing data transfer from the power transmission host to the power reception host by utilizing the conventional contactless power transmission method.

### DETAILED DESCRIPTION OF THE PREFERRED EMBODIMENTS

Hereinafter, an embodiment of the present invention will be described with reference to the drawings. Throughout the drawings, the same or corresponding components are identified by the same reference numerals and will not be described in repetition.

[Schematic Configuration of Power Transmission System]

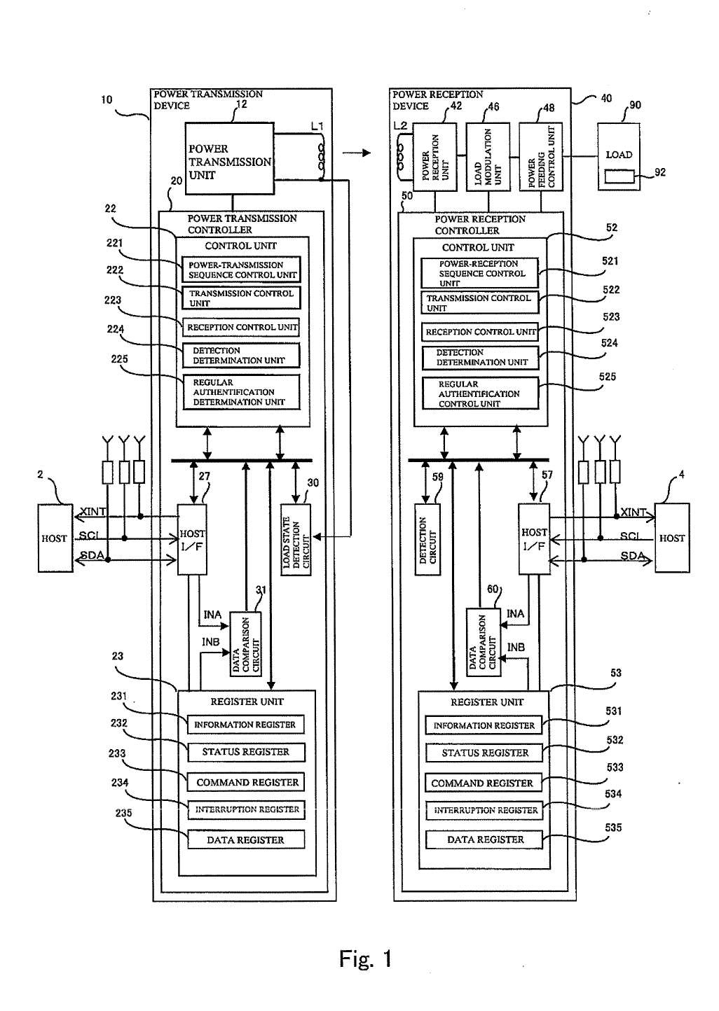

FIG. 1 is a block diagram showing the configuration of a power transmission system according to an embodiment of the present invention.

Referring to FIG. 1, the power transmission system includes a power transmission device 10 including a primary coil L1 and a power reception device 40 including a secondary coil L2, and is configured such that the primary coil L1 and the secondary coil L2 are electromagnetically coupled together to construct a power transmission transformer. This enables electric power to be transmitted from the power transmission device 10 to the power reception device 40, and hence the electric power to be supplied to a load 90.

A host 2 at a power transmission side (power transmission host 2) and the power transmission device 10 are built into an apparatus at a power transmission side. The apparatus at the power transmission side is, for example, a charging apparatus. A host 4 at a power reception side (power reception host 4) and the power reception device 40 are built into electronic equipment at a power reception side. The electronic equipment at the power reception side is, for example, a cellular phone, an electric shaver, an electric brush, a wrist computer, a handy terminal, a watch, a codeless phone, a PDA (personal digital assistance), an electric vehicle, an IC card, etc. In a case where the power reception electronic equipment is, for example, the cellular phone, the cellular phone is used as follows. When transmission of electric power is necessary, the cellular phone is placed in close proximity on a specified flat surface of the charging apparatus in a contactless (wireless) manner to allow a magnetic flux of the primary coil L1 to pass through the secondary coil L2. On the other hand, when transmission of electric power is unnecessary, the cellular phone is placed physically apart from the charging apparatus to prevent the magnetic flux of the primary coil L1 from passing through the secondary coil L2.

In the power transmission system of FIG. 1, a host I/F 27 and a host I/F 57 are provided at the power transmission side and the power reception side, respectively to enable data communication between the power transmission host 2 and the power reception host 4. Thus, by utilizing a contactless (wireless) power transmission period (charging period of a battery 92), or the like, communication of application data between the charging apparatus at the power transmission side and the electronic equipment at the power reception side, is enabled. For example, the application data communicated between the hosts during the charging period of the battery 92 is, for example, data of a lighting pattern of an LED included in the electronic equipment at the power reception side, voice data output from a speaker included in the electronic equipment during the charging period, other data relating to charging of the battery, etc.

The data communication from the power transmission side to the power reception side is implemented by transmitting a power transmission wave modulated (frequency-modulated, phase-modulated, or frequency-phase-modulated) according to the data. Specifically, in the case of transmitting data “1” to the power reception device 40, the power transmission unit 12 generates an AC voltage with a frequency f1, while in the case of transmitting data “0” to the power reception device 40, the power transmission unit 12 generates an AC voltage with a frequency f2. In this way, the AC power including the data is transmitted from the power transmission side to the power reception side. As a result, a detection circuit 59 included in the power reception device 40 detects a change in the frequency of the power transmission waveform and demodulates this change, thereby detecting the data “1” or the data “0” transmitted from the power transmission side.

By comparison, data communication from the power reception side to the power transmission side is implemented by load modulation. Specifically, a load modulation unit 46 at the power reception side changes a load state at the power reception side according to the content of data transmitted to the power transmission side, thereby changing a waveform of a voltage (power transmission waveform) induced on the primary coil L1. For example, when the data “1” is transmitted from the power reception side to the power transmission side, the power reception side is placed in a high-load state, while when the data “0” is transmitted from the power reception side to the power transmission side, the power reception side is placed in a low-load state. Thus, a load state detection circuit 30 at the power transmission side detects and demodulates the change in the load state at the power reception side based on a voltage induced on the primary coil L1 due to the load modulation at the power reception side, thereby detecting the data “1” or the data “0” transmitted from the power reception side.

[Configuration of Power Transmission Side in Power Transmission System]

Hereinafter, the configuration of the power transmission side in the power transmission system of FIG. 1 will be described.

The power transmission host 2 is implemented by for example, a CPU, an application processor, an ASIC circuit, etc., and performs various processes such as overall control process of the electronic equipment at the power transmission side including the power transmission host 2 and the power transmission device 10.

The power transmission device (also referred to as primary module) 10 includes the power transmission host 2, the primary coil L1, a power transmission unit 12, and a power transmission controller 20.

The primary coil (also referred to as power transmission coil) L1 is electromagnetically coupled to the secondary coil (also referred to as power reception coil) L2 to construct a power transmission transformer.

During the power transmission, the power transmission unit 12 generates an AC voltage with a predetermined frequency corresponding to a drive signal and applies the AC voltage to the primary coil L1. On the other hand, during the data transfer, the power transmission unit 12 generates an AC voltage with a different frequency corresponding to the data transmitted to the power reception side and applies the AC voltage to the primary coil L1. The power transmission unit 12 includes, for example, a first power transmission driver for driving one end of the primary coil L1 and a second power transmission driver for driving the other end of the primary coil L1. Each of the first and second power transmission drivers included in the power transmission unit 12 is implemented by inverter circuits constituted by, for example, power-MOS transistors, and is controlled by the power transmission controller 20.

The power transmission controller 20 is configured to perform control processes for the components of the power transmission device 10, and is implemented by an integrated circuit, a microcomputer, programs of the microcomputer, etc. The power transmission controller 20 includes a control unit 22, a register unit 23, a host interface (hereinafter will be referred to as host I/F) 27, and a load state detection circuit 30.

The control unit 22 controls the power transmission controller 20 and the power transmission device 10. The control unit 22 is implemented by, for example, an ASIC circuit such as a gate array, or programs of a microcomputer. The control unit 22 controls the power transmission unit 12, the resister unit 23, and the load state detection circuit 30. Specifically, the control unit 22 performs sequence control and determination processes required for power transmission, load state detection, frequency modulation, etc. The control unit 22 includes a power-transmission sequence control unit 221, a transmission control unit 222, a reception control unit 223, a detection determination unit 224, and a regular authentification determination unit 225.

The power-transmission sequence control unit 221 performs sequence control for contactless power transmission (normal power transmission, temporary power transmission) of the contactless power transmission method. The transmission control unit 222 controls a process for transmitting data to the power reception side by, for example, the frequency modulation. The reception control unit 223 controls a process for receiving the data transmitted from the power reception side, by the load modulation. The detection determination unit 224 determines whether or not data, foreign matters, hacking, etc., have been detected, based on a result of the detection performed by the load state detection circuit 30, when the load state detection circuit 30 detects the load state of the power reception side. The regular authentification determination unit 225 determines whether or not a proper authentification process has been performed, for example, when the power reception side performs the authentification process, after the normal power transmission starts.

The register unit 23 can be accessed by the power transmission host 2 via the host I/F27 such that data is written to and read from the register unit 23. The register unit 23 may be implemented by for example, an RAM, a D flip flop, etc. The register unit 23 includes an information register 231, a status register 232, a command register 233, an interruption register 234, and a data register 235.

The information register 231 is configured to store information, such as transmission conditions or the communication conditions, etc., of the contactless electric power transmission. The information register 231 is configured to store, for example, a parameter of a drive frequency, a parameter of a drive voltage, a parameter (threshold) for detecting the load state at the power reception side, etc.

The status register 232 is configured to allow the power transmission host 2 to confirm statuses such as a power transmission status and a communication status. The status register 232 contains bits used to confirm (notify) that the primary coil L1 is driven and is in a power transmission state, or bits used to confirm a power transmission error. Specifically, the status register 232 contains bits used to allow the power transmission host 2 to confirm the charged state of the battery 92 at the power reception side. For example, the status register 232 contains bits used to confirm that the battery 92 at the power reception side is in a fully charged state and has shifted to a fully charged mode, and bits used to confirm that a state of a sequence of the power transmission side is a charging sequence. The bits allows the power transmission host 2 to confirm the power transmission state of the contactless power transmission method, the charged state of the battery 92, etc., by utilizing the resister unit 23 provided for inter-host communication. As a result, control that is more intelligent can be implemented.

The command register 233 is configured to allow the power transmission host 2 to write commands thereto.

The interruption register 234 is associated with interruptions. For example, the interruption register 234 corresponds to a register used to set permission/inhibition of the interruptions, a register used to notify the power transmission host 2 of a particular factor of the interruption, etc. For example, the interruption register 234 contains bits used to notify the power transmission host 2 that a data transfer command issued by the power reception host 4 has been received if the data transfer command has been received. This allows the power transmission host 2 to perform another processes before a notice of the interruption has arrives. Therefore, for example, processing burden on the power transmission host 2 can be reduced. In addition, the interruption register 234 contains bits used to notify the power transmission host 2 that charging of the battery 92 has been started. This allows the power transmission host 2 to detect a timing when charging of the battery 92 has started. Based on the detected timing, control processes corresponding to the application can be implemented.

The data register 235 corresponds to a “first data storage unit” of the present invention. The data resister 235 is configured to store data which has been received from the power transmission host 2 via the host I/F 27 and is to be transmitted to the power reception host 4, and data received from the power reception host 4. The data register 235 is configured to perform generation management of a history of each data type, every time the data is received via the host I/F 27 or every time the data is received from the power reception host 4.

The host I/F 27 corresponds to a “first host interface” of the present invention. The host I/F 27 is an interface for performing communication with the power transmission host 2. In an exemplary configuration of FIG. 1, I2C (Inter Integrated Circuit) is used as the host I/F 27. I2C is a communication method for communicating data among a plurality of devices arranged within a short distance, such as within the same board. Specifically, I2C implements data communication by sharing two signal lines composed of SDA (serial data) and SCL (serial clock) as buses between one device which is a master and a plurality of devices which are slaves other than the master. The slaves are able to perform an interruption with respect to the master, by using XINT (external interrupt). Or, the slaves are able to make an interruption request from the I2C bus.

The load state detection circuit 30 detects a change in a voltage waveform induced on the primary coil L1 based on the load modulation at the power reception side, thereby detecting the load state (load fluctuation, the load is high or low) at the power reception side. For example, a change of a load current as the load state at the power reception state causes a change of a voltage waveform induced on the primary coil L1. The load state detection circuit 30 detects (demodulates) the change in the waveform and outputs data indicating a result of the detection, to the control unit 22. Based on this data received from the load state detection circuit 30, the control unit 22 at the power transmission side determines the load state at the power reception side and detects the data transmitted from the power reception side.

A data comparison circuit 31 corresponds to a “first comparison unit” of the present invention. The data comparison circuit 31 is a digital or analog comparator for comparing the data newly received from the power transmission host 2 via the host I/F27, to the data stored in the data register 235 to determine whether or not there is a match between these data. If these data do not match, the control unit 22 outputs to the power transmission unit 12 a drive signal modulated according to the data newly received and transmits the newly received data to the power reception host 4 of the power reception device 40. On the other hand, if there is a match between these data, the control unit 22 does not transmit the newly received data to the power reception host 4 of the power reception device 40.

[Configuration of Power Reception Side in Power Transmission System]

Hereinafter, the configuration of the power reception side in the power transmission system of FIG. 1 will be described.

The power reception host 4 is implemented by, for example, a CPU, an application processor, an ASIC circuit, etc., and performs processes such as overall control process of the electronic equipment at the power reception side, including the power reception host 4 and the power reception device 40.

The power reception device (also referred to as secondary module) 40 includes the secondary coil L2, a power reception unit 42, a load modulation unit 46, a power feeding controller 48, and a power reception controller 50.

The power reception unit 42 converts an AC induced voltage of the secondary coil L2 into a DC voltage. This conversion is implemented by a rectification circuit, or the like included in the power reception unit 42.

The load modulation unit 46 performs a load modulation process. Specifically, the load modulation unit 46 changes the load state according to the data to be transmitted, when the data is transmitted from the power reception side to the power transmission side, thereby changing the waveform of the induced voltage of the primary coil L1. In other words, the load modulation unit 46 changes the load at the power reception side according to the data to be transmitted, thereby amplitude modulating the induced voltage of the primary coil L1. The power feeding control unit 48 controls activation/deactivation of the power feeding to the load 90. Specifically, the power feeding control unit 48 generates a power-supply voltage by adjusting a level of the DC voltage from the power reception unit 42 and supplies the power-supply voltage to the load 90, thereby charging the battery 92 of the load 90.

The power reception controller 50 is configured to perform control processes of the components of the power reception device 40, and is implemented by an integrated circuit (IC), a microcomputer which is operative based on programs, etc. The power reception controller 50 is operative by the power-supply voltage generated from the induced voltage of the secondary coil L2. The power reception controller 50 includes a control unit 52, a register unit 53, a host I/F 57, and a detection circuit 59.

The control unit 52 controls the power reception controller 50 and the power reception device 40. The control unit 52 is implemented by an ASIC circuit such as a gate array, programs of a microcomputer, etc. The control unit 52 controls the load modulation unit 46, the power feeding control unit 48, and the register unit 53. Specifically, the control unit 52 performs sequence control and determination processes which are required for position detection, frequency detection, load modulation, fully charged state detection, etc.

The control unit 52 includes a power-reception sequence control unit 521, a transmission control unit 522, a reception control unit 523, a detection determination unit 524, and a regular authentification control unit 525.

The power-reception sequence control unit 521 performs sequence control for the power reception of the contactless power transmission method.

The transmission control unit 522 controls a process for transmitting data to the power transmission side by, for example, load modulation. The power reception control unit 523 controls a process for receiving data from the power transmission side by, for example, frequency demodulation.

The detection determination unit 524 performs detection determination based on detected information, when the detection circuit 59 detects a position, or a frequency.

The regular authentification control unit 525 controls regular authentification performed after starting normal power transmission. For example, to detect a hacked state by foreign matters, the regular authentification control unit 525 changes the load state at the power reception side regularly (intermittently) after starting normal power transmission.

The register unit 53 can be accessed by the power reception host 4 via the host I/F57, and may be implemented by for example, an RAM, a D flip flop, etc. The register unit 53 includes an information register 531, a status register 532, a command register 533, an interruption register 534, and a data register 535. The data register 535 corresponds to a “second data storage unit” of the present invention. The data resister 535 is configured to store data which has been received from the power transmission host 2 via the host I/F 27 and is to be transmitted to the power reception host 4, and data received from the power reception host 4. The status register 532 contains bits to allow the power reception host 4 to confirm the charged state of the battery 92. For example, the status register 532 contains bits used to confirm that the battery 92 is in a fully charged state and has shifted to a fully charged mode and bits used to confirm that a state of a sequence at the power reception side is a charging sequence. The bits allows the power reception host 4 to confirm the charged state of the battery 92, etc., by utilizing the resister unit 53 provided for inter-host communication. As a result, more intelligent charging control or the like can be implemented. The other register functions are similar to those of the registers at the power transmission side, and will not be described in repetition.

The host I/F 57 is an interface for performing communication with the power reception host 4. Like the host I/F27, in an exemplary configuration of FIG. 1, I2C (Inter Integrated Circuit) is used as the host I/F 57.

The detection circuit 59 detects the positional relationship between the primary coil L1 and the secondary coil L2, a coil drive frequency of data transmission from the power transmission side to the power reception side, etc.

A data comparison circuit 60 corresponds to a “second comparison unit” of the present invention. The data comparison circuit 60 compares the data newly received from the power reception host 4 via the host I/F57, to the data stored in the data register 535 to determine whether or not there is a match between these data. If the data comparison circuit 60 determines that there is a match between the data, the control unit 52 does not transmit the newly received data to the power transmission host 2 of the power transmission device 10. If the data comparison circuit 60 determines that these data do not match, the control unit 52 transmits the newly received data to the power transmission host 2 of the power transmission device 10.

[Data Communication Method of Power Transmission System]

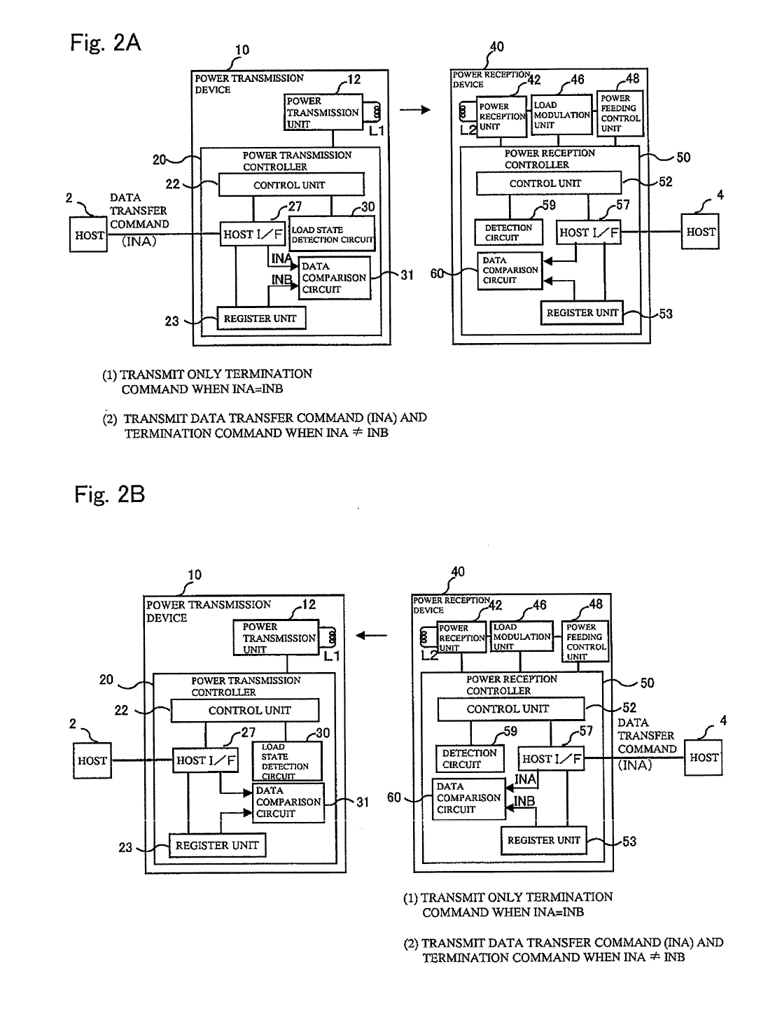

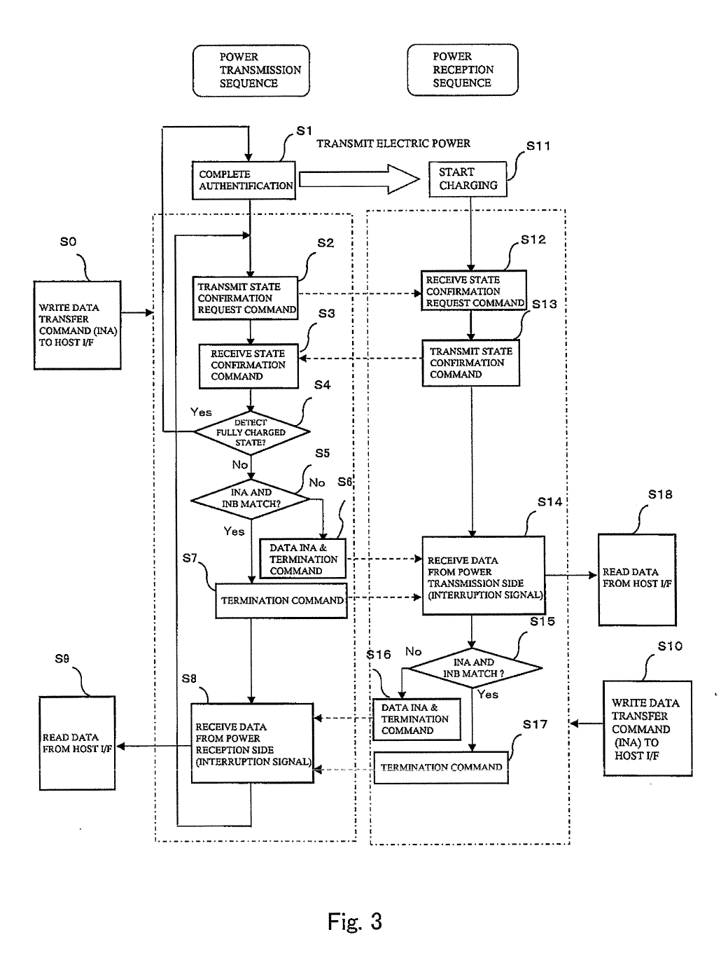

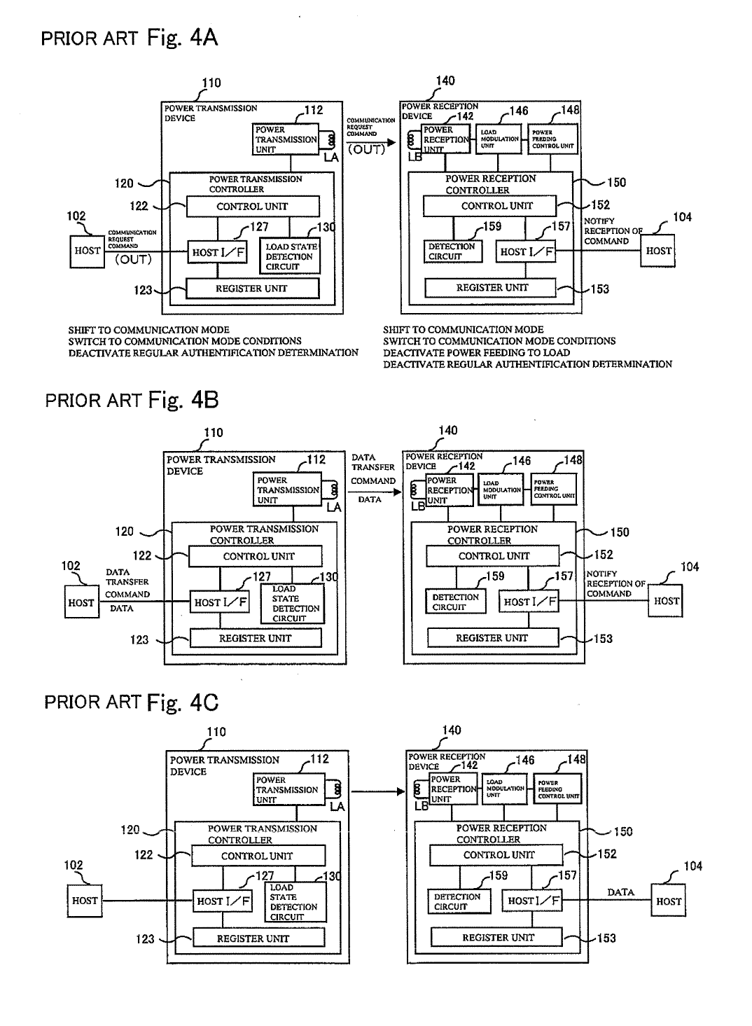

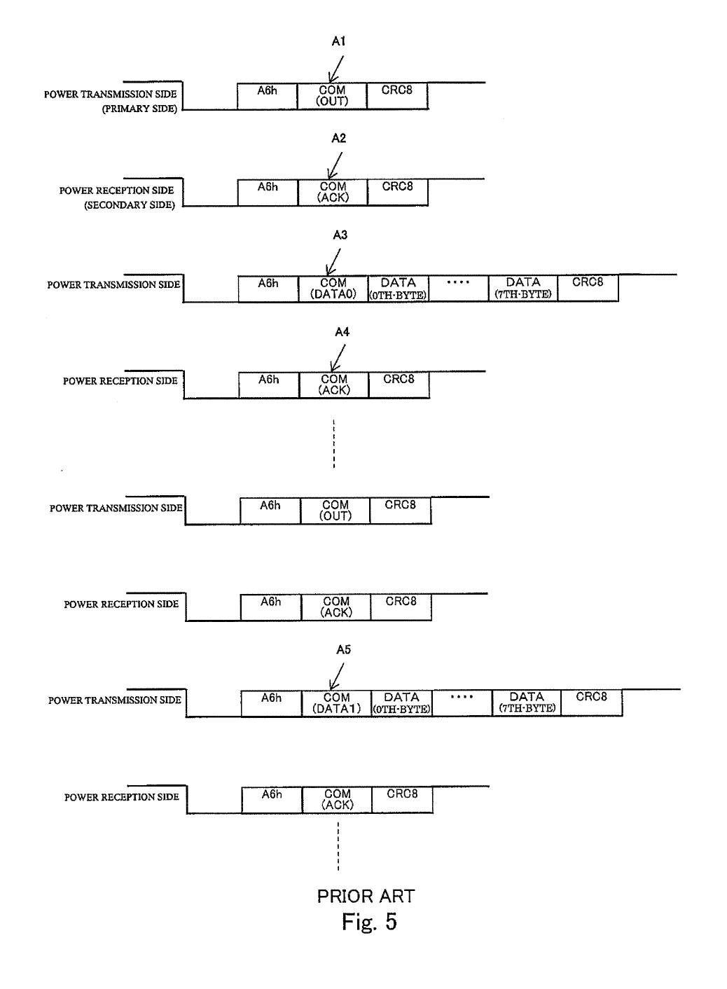

Hereinafter, a data communication method of the power transmission system of the present invention will be described with reference to FIGS. 2 and 3. FIG. 2A is a block diagram showing a method of data communication from the power transmission side to the power reception side. FIG. 2B is a block diagram showing a method of data communication from the power reception side to the power transmission side. FIG. 3 is a flowchart showing the data communication method of the power transmission system according to the embodiment of the present invention.

Initially, prior to starting of the normal power transmission, the power transmission device 10 starts temporary power transmission (power transmission for position detection). Thereby, a power-supply voltage is supplied to the power reception device 40, to turn ON the power reception device 40. The power reception device 40 determines whether or not the positional relationship between the primary coil L1 and the secondary coil L2 is proper. If it is determined that the positional relationship is proper, the authentification process between the power transmission side and the power reception side is performed. After the authentification process or the like is completed, and it is confirmed that the power transmission side and the power reception side are proper, and compatibility between the power transmission side and the power reception side is confirmed, the host I/F 27 at the power transmission side or the host I/F 57 at the power reception side is placed in a state in which it is able to accept a data transfer command, thereby implementing proper data communication. In addition, since data can be communicated between the power transmission host 2 and the power reception host 4 by utilizing a normal power transmission period (charging period), convenience of the user can be improved.

When the authentification process between the power transmission side and the power reception side is completed properly (step S1), for example, a start frame is transmitted from the power reception side to the power transmission side. Thereby, the power transmission side starts normal power transmission (power transmission) to the power reception side, and hence charging of the battery 92 of the load 90, or the like, starts (step S11). After the authentification process has been completed and the normal power transmission has started, the control unit 22 at the power transmission side places the host I/F 27 in a state in which it is able to accept the data transfer command issued from the power transmission host 2 to the host I/F 27. In other words, during the charging period, at appropriate times, the power transmission host 2 issues the data transfer command to the host I/F 27 according to an application to be executed by the electronic equipment at the power reception side (step S0). At this time, the data transfer command is stored in the command register 233 of the register unit 23 via the host I/F 27. Data transmitted along with the data transfer command is stored in the data register 235 and transferred to one of inputs of the data comparison circuit 31. After the authentification process has been completed and the normal power transmission has started, the control unit 52 at the power reception side places the host I/F 57 in a state in which it is able to accept the data transfer command issued from the power reception host 4 to the host I/F 57.

Next, the control unit 22 at the power transmission side issues a state confirmation request command for confirming states at the power reception side, such as the changed state of the battery 92 of the load 90, the output voltage of the power feeding control unit 48, and a detected temperature, and transmits the state confirmation request command to the power reception device 40 according to the contactless power transmission method (step S2). Receiving the state confirmation request command from the power transmission device 10 (step S12), the power reception device 40 transmits a state confirmation command indicating a result of confirmation of the states at the power reception side to the power transmission device 10 in the form of packets (step S13).

Then, the power transmission device 10 receives the state confirmation command from the power reception device 40 (step S3). Then, the control unit 22 at the power transmission side decodes the state confirmation command and confirms its content, to determine whether or not the control unit 22 is allowed to transmit data associated with the data transfer command issued from the power transmission host 2 to the power reception side. Particularly, the control unit 22 at the power transmission side determines whether or not the charged state of the battery 92 of the load 90, which is included in the state confirmation command, is a fully charged state (step S4). If it is determined that the battery 92 is in the fully charged state (step S4: NO), the process returns to step S1, and the authentification process resumes.

On the other hand, if it is determined that the battery 92 is not in the fully charged state (step S4: YES), the data comparison circuit 31 compares data INA newly received from the power transmission host 2 via the host I/F 27 during the charging period to data INB previously stored and preserved in the data register 235 (step S5).

If there is a match between the data INA and the data INB (INA=INB) (step S5: YES), the control unit 22 at the power transmission side transmits only a predetermined termination command to the power reception side without transmitting the data INA newly received from the power transmission host 2 (step S7). Thereby, the power reception side confirms that there is no change in the content of the data transfer command newly issued from the power transmission host 2.

If the data INA and the data INB do not match (INA≠INB) (step S5: NO), the control unit 22 at the power transmission side transmits the data INA and the predetermined termination command to the power reception side (step S6).

Receiving the data INA and the predetermined termination command from the power transmission device 10 (step S14), the power reception device 40 stores the data INA and the predetermined termination command in a predetermined register of the register unit 53. At this time, the control unit 52 at the power reception side outputs an interruption signal to the power reception host 4 (step S14). Therefore, the power reception host 4 can read the data stored in the data register 535 of the register unit 53 via the host I/F 57 (step S18).

When the sequence of the data communication from the power transmission side to the power reception side ends, a sequence of data communication from the power reception side to the power transmission side starts after that.

The data comparison circuit 31 compares data INA newly received from the power reception host 4 via the host I/F 57 during the charging period to data INB previously stored and preserved in the data register 535 (step S15).

If there is a match between the data INA and the data INB (INA=INB) (step S15: YES), the control unit 52 at the power reception side transmits only a predetermined termination command to the power transmission side without transmitting the data INA newly received from the power reception host 4 (step S17). Thereby, the power reception side confirms that there is no change in the content of the data transfer command newly issued from the power reception host 4.

If the data INA and the data INB do not match (INA≠INB) (step S15: NO), the control unit 52 at the power reception side transmits the data INA and the predetermined termination command to the power transmission side (step S16).

Receiving the data INA and the predetermined termination command from the power reception device 40 (step S8), the power transmission device 10 stores the data INA and the predetermined termination command in a predetermined register of the register unit 23. At this time, the control unit 22 at the power transmission side outputs an interruption signal to the power transmission host 2 (step S8). Therefore, the power transmission host 2 can read the data stored in the data register 235 of the register unit 23 via the host I/F 27 (step S9).

When the sequence of the data communication from the power reception side to the power transmission side ends, the process returns to step S1 to resume the sequence of data communication from the power transmission side to the power reception side.

### Modified Example

The power transmission device 10 and the power transmission controller 20 are not limited to those shown in FIG. 1, but a part of the components may be omitted, another components may be added, a connection relation may be changed, etc. For example, the power transmission unit 12 may be built into the power transmission controller 20, or the load state detection circuit 30 may be externally attached to the power transmission controller 20. Or, the load state detection circuit 30 may be omitted. Or, a waveform monitor circuit may be added.

The power reception device 40 and the power reception controller 50 are not limited to those shown in FIG. 1, but a part of the components may be omitted, another components may be added, a connection relation may be changed, etc. For example, any one of the power reception unit 42, the load modulation unit 46 and the power feeding control unit 48 may be built into the power reception controller 50. Or, the load modulation unit 46 may be omitted.

The communication method between the power transmission host 2 and the host I/F 27, and the communication method between the power reception host 4 and the host I/F 57, are not limited to the above stated I2C, but may be a communication method based on a concept similar to that of I2C, a normal serial interface, or a parallel interface.

Information (e.g., information stored in the information register 531) stored in the register units 23, 53, may be stored in a nonvolatile memory (not shown) such as a flash memory, or a masked ROM.

The present invention is advantageous to a power transmission system in which there is a great traffic quantity in application data communication based on a contactless power transmission method which is performed between a power transmission host and a power reception host during a charging period of a battery of a load.

Numeral modifications and alternative embodiments of the present invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

1. A power transmission controller included in a power transmission device in a power transmission system including the power transmission device, and a power reception device, the power transmission device including a power transmission unit which is connectable to a primary coil and drives the primary coil based on a drive signal and transmits AC power corresponding to the drive signal, the power reception device including a power reception unit which is connectable to a secondary coil and receives AC power induced by the secondary coil, the power transmission controller comprising:
a control unit configured to output the drive signal modulated based on data, to the power transmission unit to control a driving operation of the power transmission unit;
a data storage unit configured to store data transferred from the power transmission device to the power reception device every time an input signal containing the data is input to the power transmission device; and
a comparison unit configured to receive as inputs data contained in an input signal which is newly input to the power transmission device and the data stored in the data storage unit, respectively, and compare the data contained in the input signal to the data stored in the data storage unit to determine whether or not there is a match between the data contained in the input signal and the data stored in the data storage unit;
wherein the control unit is configured to output a drive signal modulated based on the newly input data to the power transmission unit and transmit only the newly input data to the power reception device, if the comparison unit determines that the data contained in the input signal and the data stored in the storage unit do not match; and
the control unit is configured not to transmit the newly input data to the power reception device, if the comparison unit determines that there is a match between the data contained in the input signal and the data stored in the storage unit.

2. The power transmission controller according to claim 1, further comprising:
a host interface configured to perform communication between a power transmission host and the power transmission device,
wherein the data storage unit is accessible by the power transmission host via the host interface.

3. A power reception controller included in a power reception device in a power transmission system including a power transmission device, and the power reception device, the power transmission device including a power transmission unit which is connectable to a primary coil and drives the primary coil based on a drive signal and transmits AC power corresponding to the drive signal, the power reception device including a power reception unit which is connectable to a secondary coil and receives AC power induced by the secondary coil, the power reception controller comprising:
a control unit configured to change a load state at a power reception side with respect to electric power received in the power reception unit;
a data storage unit configured to store data transferred from the power reception device to the power transmission device every time an input signal containing the data is input to the power reception device; and
a comparison unit configured to receive as inputs data contained in an input signal which is newly input to the power reception device and the data stored in the data storage unit, respectively, and compare the data contained in the input signal to the data stored in the data storage unit to determine whether or not there is a match between the data contained in the input signal and the data stored in the data storage unit;
wherein the control unit is configured to change the load state at the power reception side based on the newly input data and transmit only the newly input data to the power transmission device, if the comparison unit determines that the data contained in the input signal and the data stored in the data storage unit do not match; and
the control unit is configured not to transmit the newly input data to the power transmission device, if the comparison unit determines that there is a match between the data contained in the input signal and the data stored in the storage unit.

4. The power reception controller according to claim 3, further comprising:
a host interface configured to perform communication between a power reception host and the power reception device;
wherein the data storage unit is accessible by the power reception host via the host interface.

5. A power transmission system comprising a power transmission device including a power transmission unit which is connectable to a primary coil and drives the primary coil based on a drive signal and transmits AC power corresponding to the drive signal and a power reception device including a power reception unit which is connectable to a secondary coil and receives AC power induced by the secondary coil,
wherein the power transmission device includes:
a first control unit configured to output the drive signal modulated based on data, to the power transmission unit to control a driving operation of the power transmission unit;
a first data storage unit configured to store data transferred from the power transmission device to the power reception device every time an input signal containing the data is input to the power transmission device; and
a first comparison unit configured to receives as inputs data contained in an input signal which is newly input to the power transmission device and the data stored in the first data storage unit, respectively, and compare the data contained in the input signal to the data stored in the first data storage unit to determine whether or not there is a match between the data contained in the input signal and the data stored in the first data storage unit;
wherein the first control unit is configured to output a drive signal modulated based on the newly input data to the power transmission unit and transmit only the newly input data to the power reception device, if the first comparison unit determines that the data contained in the input signal and the data stored in the first data storage unit do not match; and
the first control unit is configured not to transmit the newly input data to the power reception device if the first comparison unit determines that there is a match between the data contained in the input signal and the data stored in the first data storage unit;
wherein the power reception device includes:
a second control unit configured to change a load state at a power reception side with respect to electric power received in the power reception unit;
a second data storage unit configured to store data transferred from the power reception host to a power transmission host of the power transmission device every time an input signal containing the data is input to the power reception device;
a second comparison unit configured to receives as inputs data contained in an input signal which is newly input and the power reception device and the data stored in the second data storage unit, respectively, and compare the data contained in the input signal to the data stored in the second data storage unit to determine whether or not there is a match between the data contained in the input signal and the data stored in the second data storage unit;
wherein the second control unit is configured to change the load state at the power reception side based on the newly input data and transmit only the newly input data to the power transmission device, if the second comparison unit determines that the data contained in the input signal and the data stored in the second data storage unit do not match; and
the second control unit is configured not to transmit the newly input data to the power transmission device, if the second comparison unit determines that there is a match between the data contained in the input signal and the data stored in the second data storage unit.

6. The power transmission system according to claim 5, further comprising:
a first host interface configured to perform communication between the power transmission host and the power transmission device,
wherein the first data storage unit is accessible by the power transmission host via the first host interface.

7. The power transmission system according to claim 5, further comprising:
a second host interface configured to perform communication between a power reception host to and the power reception device;
wherein the second data storage unit is accessible by the power reception host via the second host interface.

8. The power transmission system according to claim 5, further comprising:
a load state detection circuit configured to detect data transmitted from the power reception device based on a change in a terminal electric potential of the primary coil which is caused by a change in the load state at the power reception side; wherein
the first control unit is configured to output an interruption signal, if the data is detected by the load state detection circuit.

9. The power transmission system according to claim 5, wherein
the power reception device further includes a detection circuit configured to demodulate AC power received in the power reception unit to detect the data transmitted from the power transmission device;
wherein the second control unit is configured to output an interruption signal, if the data is detected by the detection circuit.

10. A data communication method of a power transmission system comprising a power transmission device including a power transmission unit which is connectable to a primary coil and drives the primary coil based on a drive signal and transmits AC power corresponding to the drive signal and a power reception device including a power reception unit which is connectable to a secondary coil and receives AC power induced by the secondary coil,
wherein the power transmission device includes:
a first control unit configured to output the drive signal modulated based on data, to the power transmission unit to control a driving operation of the power transmission unit;
a first data storage unit configured to store data transferred from the power transmission device to the power reception device every time an input signal containing the data is input to the power transmission device; and
a first comparison unit configured to receives as inputs data contained in an input signal which is newly input to the power transmission device and the data stored in the first data storage unit, respectively, and compare the data contained in the input signal to the data stored in the first data storage unit to determine whether or not there is a match between the data contained in the input signal and the data stored in the first data storage unit;
wherein the power reception device includes:
a second control unit configured to change a load state at a power reception side with respect to electric power received in the power reception unit;
a second data storage unit configured to store data transferred from the power reception host to a power transmission host of the power transmission device every time an input signal containing the data is input to the power reception device; and
a second comparison unit configured to receives as inputs data contained in an input signal which is newly input to the power reception device and the data stored in the second data storage unit, respectively, and compare the data contained in the input signal to the data stored in the second data storage unit to determine whether or not there is a match between the data contained in the input signal and the data stored in the second data storage unit;
the data communication method comprising:
using the first control unit of the power transmission device, outputting the drive signal modulated based on the newly input data to the power transmission unit and transmitting only the newly input data to the power reception device, if the first comparison unit determines that the data contained in the input signal and the data stored in the first data storage unit do not match;
using the first control unit of the power transmission device, deactivating transmission of the newly input data to the power reception device if the first comparison unit determines that there is a match between the data contained in the input signal and the data stored in the first data storage unit;
using the second control unit of the power reception device, changing the load state at the power reception side based on the newly input data and transmitting only the newly input data to the power transmission device, if the second comparison unit determines that the data contained in the input signal and the data stored in the second data storage unit do not match; and
using the second control unit of the power reception device, deactivating transmission of the newly input data to the power transmission device, if the second comparison unit determines that there is a match between the data contained in the input signal and the data stored in the second data storage unit.
